(19) United States
(12) Patent Application Publication
(10) Pub. No.: US 2026/0284755 A1
(43) Pub. Date: Sep. 24, 2026

(54) DOOR TRIMMER

(71) Applicant: Techtronic Cordless GP, Anderson, SC (US)

(72) Inventors: Trevor C. Fauss, Greenville, SC (US); Charles M. Wacker, II, Anderson, SC (US); Jeremy Fedrigon, Greenville, SC (US)

(21) Appl. No.: 19/086,763

(22) Filed: Mar. 21, 2025

(51) Int. Cl. B23C 3/12

(52) U.S. Cl. CPC B23C 3/128

(57) ABSTRACT

A door trimmer for use with a power tool. The door trimmer includes a workpiece receiving assembly having a first guide member and a second guide member that is coupled to the first guide member to form a workpiece receiving space therebetween. The workpiece receiving space defines a distance between the first guide member and the second guide member. The door trimmer further includes a tool bit that extends between the first guide member and the second guide member. The tool bit is configured to be operably coupled to the power tool for rotation relative to the workpiece receiving assembly about a longitudinal axis. Moreover, the door trimmer includes an actuator that is coupled to the workpiece receiving assembly. The actuator is rotatable about the longitudinal axis to change the distance between the first guide member and the second guide member.

### FIELD OF THE INVENTION

The present invention relates to a door trimmer for a rotary power tool.

### BACKGROUND OF THE INVENTION

A door trimmer is a tool for use with a rotary power tool. A tool bit of the door trimmer is operably coupled to the rotary power tool to be rotated upon actuation of the rotary power tool. Rotation of the tool bit allows the door trimmer to perform a trimming operation along a workpiece, such as a door.

### SUMMARY OF THE INVENTION

The present invention provides, in one aspect, a door trimmer for use with a power tool. The door trimmer includes a workpiece receiving assembly having a first guide member and a second guide member coupled to the first guide member to form a workpiece receiving space therebetween. The workpiece receiving space defines a distance between the first guide member and the second guide member. The door trimmer further includes a tool bit extending between the first guide member and the second guide member. The tool bit is configured to be operably coupled to the power tool for rotation relative to the workpiece receiving assembly about a longitudinal axis. Moreover, the door trimmer includes an actuator that is coupled to the workpiece receiving assembly. The actuator is rotatable about the longitudinal axis to change the distance between the first guide member and the second guide member.

The present invention provides, in another aspect, a door trimmer for use with a power tool. The door trimmer includes a tool bit configured to be operably coupled to the power tool for rotation upon actuation of the power tool and a first guide member that rotatably supports the tool bit for rotation relative to the first guide member. The first guide member has a notch defined therein. The door trimmer further includes a second guide member having an arm extending therefrom and a tab that is received within the notch of the first guide member to slidably couple the second guide member to the first guide member. Moreover, the door trimmer includes an actuator having a groove that receives the arm of the second guide member such that rotation of the actuator changes a distance defined between the first guide member and the second guide member.

The present invention provides, in another aspect, a door trimmer for use with a power tool. The door trimmer includes a tool bit configured to be operably coupled to the power tool for rotation about a longitudinal axis and a first guide member that rotatably supports the tool bit for rotation relative to the first guide member. The first guide member has a first guide wall extending perpendicular to the longitudinal axis. The door trimmer further includes a second guide member having a second guide wall oriented parallel to and spaced a distance from the first guide wall. The tool bit extends between the first guide wall and the second guide wall. Moreover, the door trimmer includes a retainer assembly coupled to the first guide member to inhibit axial movement of the tool bit relative to the first guide member and an actuator that is coupled to the second guide member. The actuator is configured to rotate about the longitudinal axis to change the distance between the first guide wall and the second guide wall.

### BRIEF DESCRIPTION OF DRAWINGS

FIG. 1 is a rear perspective view of a door trimmer according to an embodiment of the present invention.

FIG. 2 is a front perspective view of the door trimmer of FIG. 1.

FIG. 3 is a perspective view of the door trimmer of FIG. 1 with portions removed.

FIG. 4 is a bottom perspective view of the door trimmer of FIG. 1

FIG. 5 is a cross-sectional view of the door trimmer of FIG. 1 taken along section line 5–5 in FIG. 1, the door trimmer including a retainer assembly.

FIG. 6 is a perspective view of a guide member of the door trimmer of FIG. 1, the guide member supporting a tool bit.

FIG. 7 is a perspective view of the tool bit of FIG. 6 and the retainer assembly of FIG. 5.

FIG. 8 is a rear perspective view of a door trimmer according to another embodiment.

FIG. 9 is a cross-sectional view of the door trimmer of FIG. 8 taken along section line 9–9 in FIG. 8, the door trimmer including a retainer assembly.

FIG. 10 is a perspective view of a tool bit and the retainer assembly of FIG. 9.

FIG. 11 is perspective view of the tool bit of FIG. 10.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

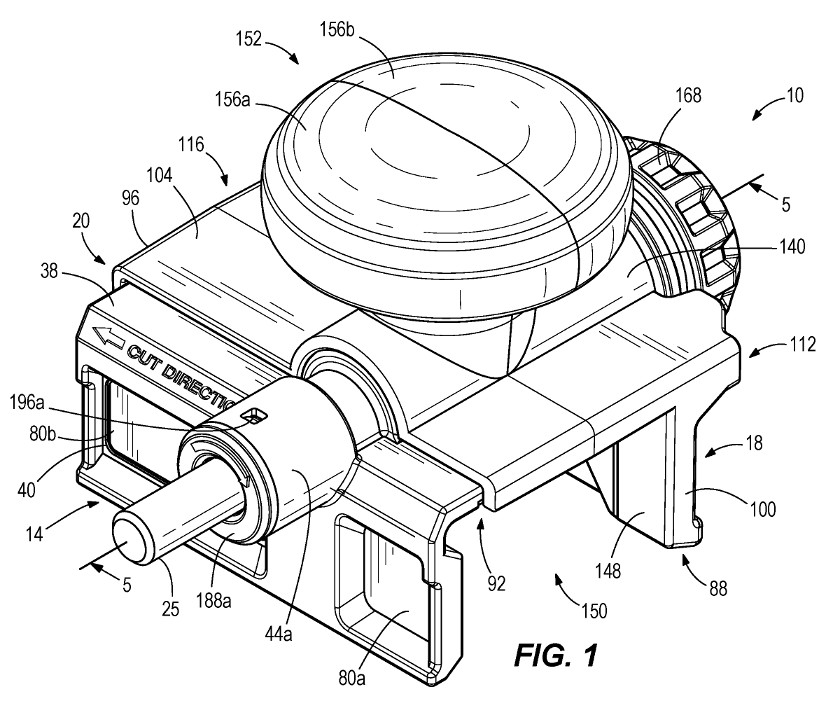

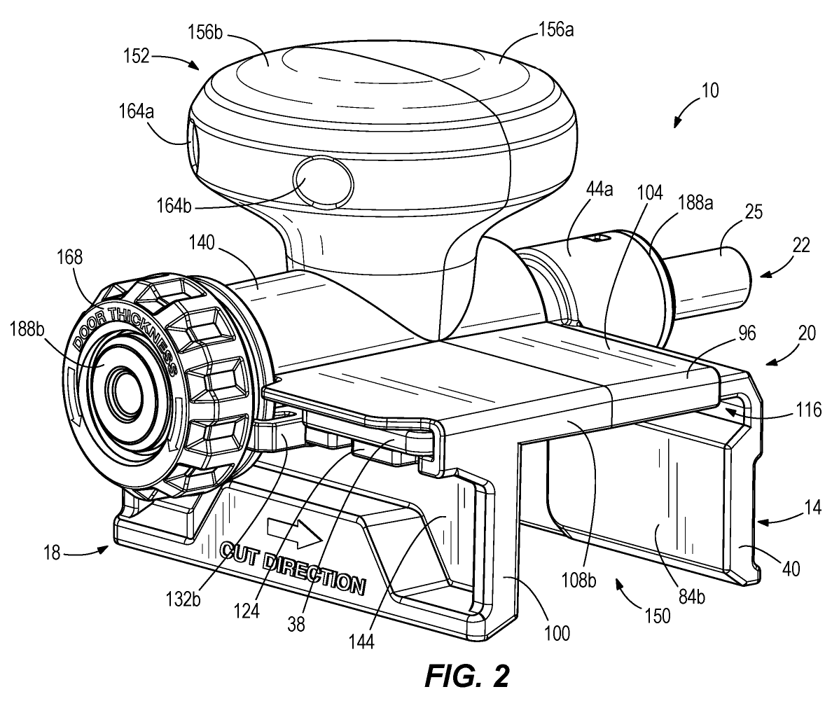

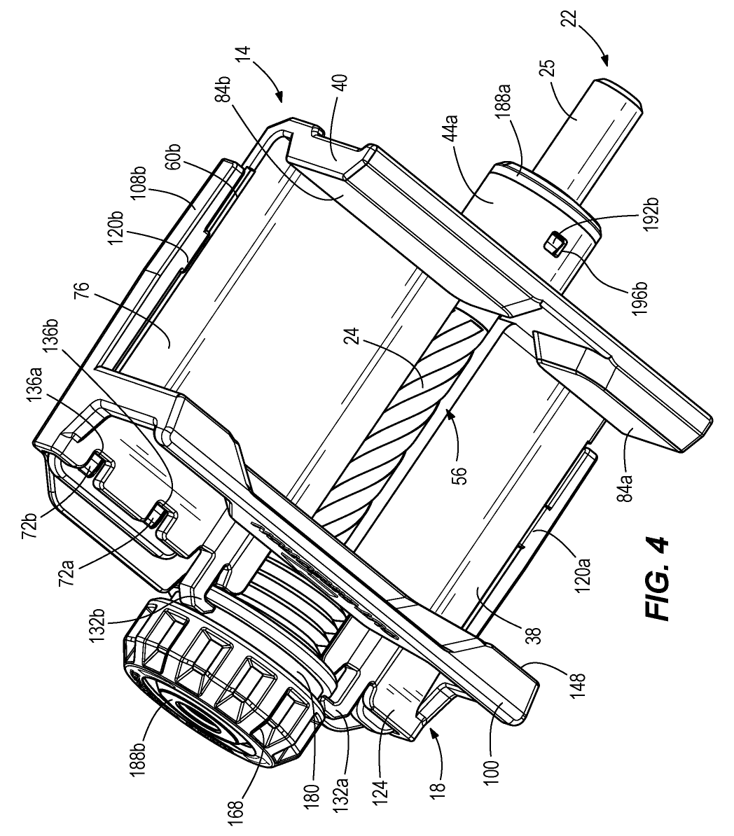

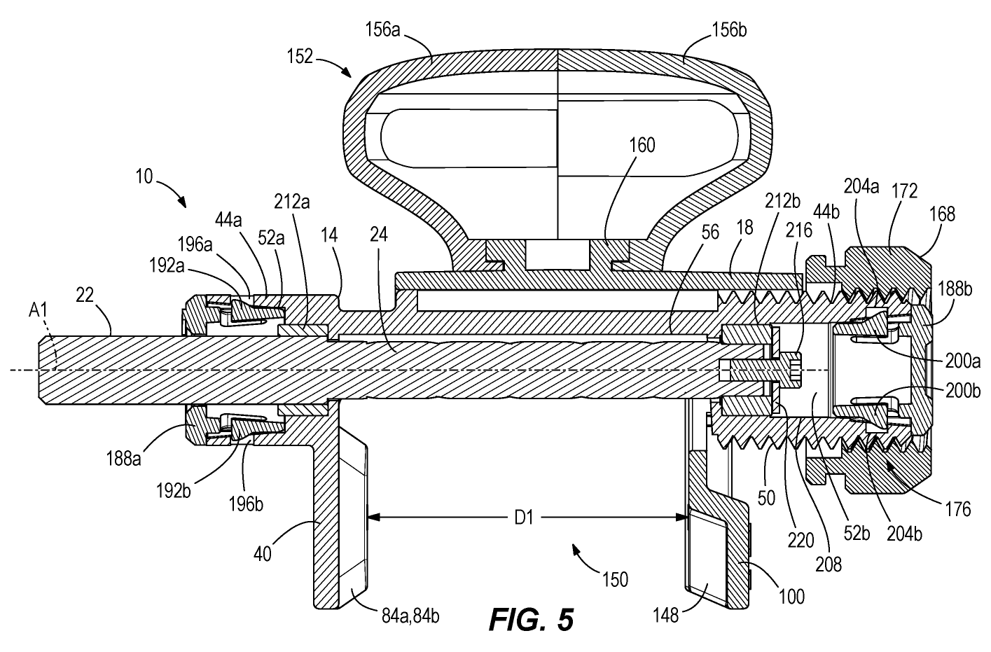

FIGS. 1 and 2 illustrate a door trimmer 10 that may be operably coupled to a rotary power tool, such as a drill. The power tool may include an electric motor supported by a housing of the power tool. A battery pack may be removably coupled to the housing of the power tool and configured to be electrically connected to the electric motor. Also, the power tool may include a chuck configured to receive a tool bit to perform work on a workpiece (e.g., a door). The door trimmer 10 includes a first guide member 14, a second guide member 18 coupled to the first guide member 14 to form a workpiece receiving assembly 20, and a tool bit 22 having a cutting portion 24 and a shank portion 25 (FIG. 4). The tool bit 22 is rotatably supported by the first guide member 14 such that the tool bit 22 is rotatable relative to the workpiece receiving assembly 20 about a longitudinal axis A1 (FIG. 5) defined by the tool bit 22.

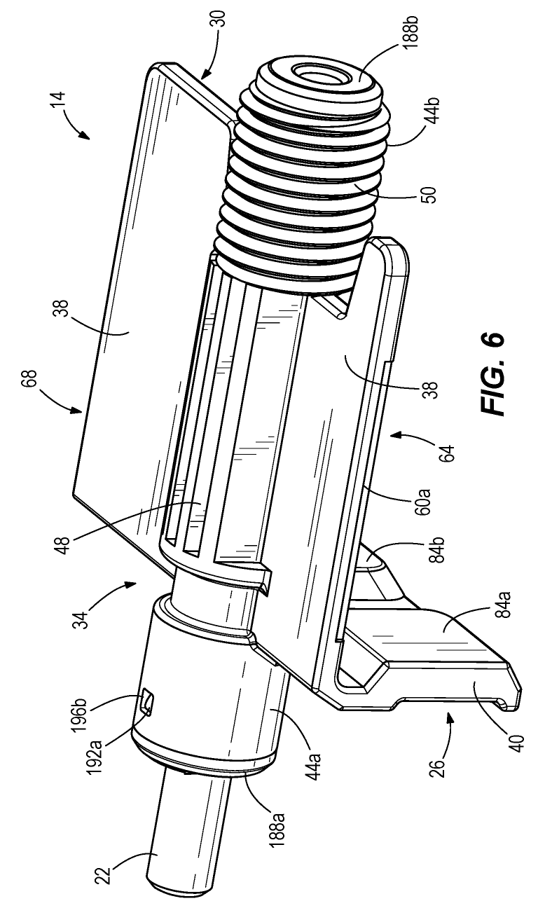

With reference to FIGS. 5 and 6, the first guide member 14 has a first end 26 and a second end 30 (FIGS. 4 and 6) opposite the first end 26. Also, the first guide member 14 has a tool bit-receiving portion 34, a first planar portion 38 extending between the first and second ends 26, 30, and a first guide wall 40 extending from the first planar portion 38 at the first end 26. The first planar portion 38 is oriented parallel to the longitudinal axis A1. The first guide wall 40 is oriented perpendicular to the first planar portion 38 and to the longitudinal axis A1.

The tool bit-receiving portion 34 of the first guide member 14 has a first receiving portion 44a extending outwardly from the first guide wall 40 at the first end 26 of the first guide member 14, a second receiving portion 44b extending outwardly from the first planar portion 38 at the second end 30 of the first guide member 14, and an arcuate portion 48 extending therebetween. The second receiving portion 44b has an external threaded portion 50 formed along the entirety of the second receiving portion 44b. In other embodiments, the external threaded portion 50 may be formed along a portion of the second receiving portion 44b. A first aperture 52a is defined within the first receiving portion 44a and a second aperture 52b is defined within the second receiving portion 44b. The arcuate portion 48 defines an opening 56 in communication with the first aperture 52a and the second aperture 52b. As such, the tool bit-receiving portion 34 is configured to receive and rotatably support the tool bit 22. The tool bit 22 extends through the first aperture 52a, the second aperture 52b, and the opening 56. As the tool bit 22 extends through the opening 56 of the arcuate portion 48, the cutting portion 24 is exposed for performing a trimming operation on a working surface or edge of a workpiece.

With reference to FIGS. 4 and 6, the first planar portion 38 of the first guide member 14 has a first notch 60a and a second notch 60b. The first notch 60a is defined on a first side 64 of the first planar portion 38. The second notch 60b is defined on a second side 68 of the first planar portion 38 opposite the first side 64. Also, two stop members 72a, 72b are formed on a bottom surface 76 of the first planar portion 38 at the second end 30 of the first guide member 14. In the illustrated embodiment, the two stop members 72a, 72b are tabs protruding from the bottom surface 76. In other embodiments, the two stop members 72a, 72b may be formed as other configurations. Two indents 80a, 80b (FIG. 1) are defined within the first guide wall 40 of the first guide member 14, and thereby form a first planar protrusion 84a and a second planar protrusion 84b that are configured to engage the workpiece.

With reference to FIGS. 1-3, the second guide member 18 has a first end 88, a second end 92 opposite the first end 88, a coupling portion 96 extending between the first and second ends 88, 92, and a second guide wall 100 extending from the coupling portion 96 at the first end 88. The coupling portion 96 is oriented parallel to the longitudinal axis A1 when the door trimmer 10 is assembled. The second guide wall 100 is oriented perpendicular to the coupling portion 96 and to the longitudinal axis A1.

The coupling portion 96 of the second guide member 18 has a second planar portion 104, a first flange 108a, and a second flange 108b. The first flange 108a extends from the second planar portion 104 at a first side 112 of the second planar portion 104. The second flange 108b extends from the second planar portion 104 at a second side 116 of the second planar portion 104 opposite the first side 112. A first tab 120a (FIG. 4) is formed on the first flange 108a and a second tab 120b (FIG. 4) is formed on the second flange 108b. Each notch 60a, 60b of the first planar portion 38 is configured to respectively receive the first tab 120a and the second tab 120b so that the second guide member 18 is slidably coupled to the first guide member 14. As such, the first tab 120a slides within the first notch 60a and the second tab 120b slides within the second notch 60b.

In addition, the coupling portion 96 has a support wall 124 integrally formed with the flanges 108a, 108b. The support wall 124 is oriented below and parallel to the second planar portion 104 such that the support wall 124 is overlapped by a portion of the second planar portion 104. The support wall 124 is spaced from the second planar portion 104 such that a gap is defined therebetween. The first planar portion 38 of the first guide member 14 extends through the gap when the first guide member 14 is coupled to the second guide member 18.

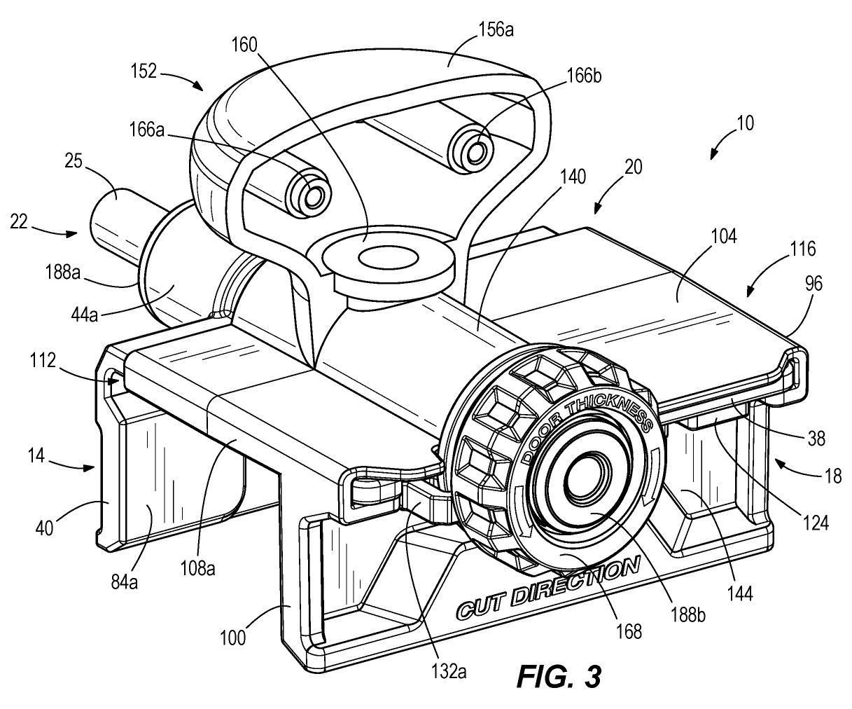

With reference to FIGS. 3 and 4, the coupling portion 96 has a first coupling arm 132a, a second coupling arm 132b, and two recesses 136a, 136b defined within the support wall 124 at the first end 88 of the second guide member 18. The coupling arms 132a, 132b extend from the support wall 124 and are spaced from each other. The recesses 136a, 136b are configured to cooperate with the stop members 72a, 72b of the first planar portion 38 of the first guide member 14. Also, the coupling portion 96 has an arcuate wall 140 integrally formed with the second planar portion 104. The arcuate wall 140 defines a cavity configured to receive the tool bit-receiving portion 34. As such, the arcuate wall 140 is sized and shaped to overlap the second receiving portion 44b and the arcuate portion 48 of the tool bit-receiving portion 34.

FIGS. 2 and 3 illustrate that the second guide wall 100 of the second guide member 18 extends from the support wall 124. The second guide wall 100 has an indent 144 defined therein and extending along a length of the second guide wall 100. The indent 144 forms a planar protrusion 148 (FIG. 4) that is arranged opposite the planar protrusions 84a, 84b of the first guide member 14. The planar protrusion 148 is configured to engage the workpiece. A workpiece receiving space 150 is thereby defined between the planar protrusions 84a, 84b of the first guide member 14 and the planar protrusion 148 of the second guide wall 100. The workpiece is to be positioned within the workpiece receiving space 150 during a trimming operation. Also, the workpiece receiving space 150 defines a distance D1 extending between the planar protrusions 84a, 84b of the first guide wall 40 and the planar protrusion 148 of the second guide wall 100.

With reference to FIGS. 1-3, the door trimmer 10 further includes a handle 152 coupled to the arcuate wall 140 of the second guide member 18. The handle 152 is configured to be grasped by a user during the trimming operation. In the illustrated embodiment, the handle 152 has a first grip portion 156a and a second grip portion 156b that clasp around a disc-shaped projection 160 extending outwardly from the arcuate wall 140. In some embodiments, the handle 152 may be integrally formed with the arcuate wall 140. In other embodiments, the handle 152 may formed as a single grip portion that is removably coupled to or integrally formed with the arcuate wall 140. In additional embodiments, the handle 152 may be coupled to any portion of the second guide member 18.

Two through bores 164a, 164b extend through the second grip portion 156b, while two blind bores 166a, 166b are defined in the first grip portion 156a. When coupling the handle 152 to the arcuate wall 140, the grip portions 156a, 156b are first positioned around the disc-shaped projection 160 such that the through bores 164a, 164b and the blind bores 166a, 166b become coaxial. Then each through bore 164a, 164b threadably receives a fastener that is also threadably received by a corresponding blind bore 166a, 166b to thereby couple the handle 152 to the arcuate wall 140.

With reference to FIGS. 3-5, the door trimmer 10 further includes an actuator 168 coupled to the workpiece receiving assembly 20. In the illustrated embodiment, the actuator 168 is a knob. The actuator 168 has a body 172, an internal threaded portion 176 formed within the body 172, and a groove 180 defined around the body 172. The internal threaded portion 176 is configured to mate with the external threaded portion 50 of the second receiving portion 44b in order to threadably couple the actuator 168 to the second receiving portion 44b of the first guide member 14. The groove 180 receives the first coupling arm 132a and the second coupling arm 132b to thereby couple the actuator 168 to the coupling portion 96 of the second guide member 18. As such, the actuator 168 is coupled to the first guide member 14 and the second guide member 18.

The user may grasp the body 172 of the actuator 168 and rotate the actuator 168 about the longitudinal axis A1. Rotation of the actuator 168 causes the actuator 168 to move along the external threaded portion 50, which causes the second guide member 18 to slide relative to the first guide member 14 in a direction parallel to the longitudinal axis A1. Sliding movement of the second guide member 18 relative to the first guide member 14 changes the distance D1 of the workpiece receiving space 150. Adjustment of the distance D1 allows the door trimmer 10 to accommodate the thickness of the workpiece. The distance D1 is also maintained without requiring a user to apply continued force or input to the door trimmer 10. To ensure that the first and second guide members 14, 18 do not uncouple from each other, the recesses 136a, 136b of the second guide member 18 receives the stop members 72a, 72b of the first guide member 14 to limit further movement of the second guide member 18 relative to the first guide member 14.

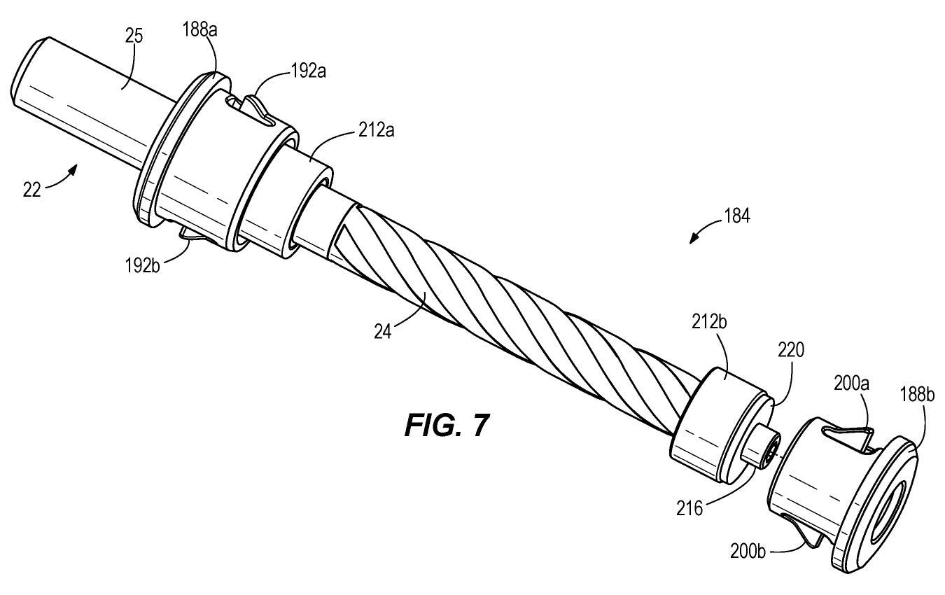

With reference to FIGS. 5 and 7, the door trimmer 10 further includes a retainer assembly 184 configured to inhibit axial movement of the tool bit 22 during the trimming operation. The retainer assembly 184 has a first retaining member or a first plug 188a and a second retaining member or a second plug 188b. The first plug 188a is received within the first aperture 52a of the first receiving portion 44a. The first plug 188a has two depressible tabs 192a, 192b configured to extend into a pair of holes 196a, 196b defined within the first receiving portion 44a, and thereby secure the first plug 188a within the first receiving portion 44a. The second plug 188b is received within the second aperture 52b of the second receiving portion 44b. The second plug 188b also has two depressible tabs 200a, 200b configured to extend into a pair of recesses 204a, 204b defined along a surface 208 of the second aperture 52b to secure the second plug 188b to the second receiving portion 44b. When the tool bit 22 is coupled to the workpiece receiving assembly 20, the tool bit 22 does not extend through the second plug 188b, but the tool bit 22 extends through and out of the first plug 188a. The shank portion 25 of the tool bit 22 extends out of the first receiving portion 44a to be operably coupled to the chuck of the power tool. For removal of the tool bit 22 from the first guide member 14 of the workpiece receiving assembly 20, the depressible tabs 192a, 192b of the first plug 188a may be depressed to allow the first plug 188a to be removed from the first receiving portion 44a.

In addition, the retainer assembly 184 has a first bushing 212a, a second bushing 212b, a fastener 216 configured secure the tool bit 22 within the tool bit-receiving portion 34, and a washer 220 arranged between the second bushing 212b and the fastener 216. The first bushing 212a is disposed within the first aperture 52a of the first receiving portion 44a and the second bushing 212b is disposed within the second aperture 52b of the second receiving portion 44b. The tool bit 22 extends through the first and second bushings 212a, 212b to be rotatably supported.

During operation, the workpiece is positioned within the workpiece receiving space 150. The first guide wall 40 of the first guide member 14 is positioned on a first side of the workpiece and the second guide wall 100 of the second guide member 18 is positioned on a second side of the workpiece, opposite the first side. The second guide member 18 is moved relative to the first guide member 14 by rotation of the actuator 168 to change the distance D1 of the workpiece receiving space 150. The actuator 168 is rotated until the second guide member 18 reaches a desired positioned and the distance D1 is changed such that the workpiece receiving space 150 is able to accommodate the thickness of the workpiece. Once the second guide member 18 is adjusted to the desired position, the planar protrusions 84a, 84b of the first guide wall 40 engages the first side of the workpiece and the planar protrusion 148 of the second guide wall 100 engages the second side of the workpiece. The cutting portion 24 of the tool bit 22 is thereby arranged to engage the working surface of the workpiece. The power tool may then be actuated to rotate the cutting portion 24 of the tool bit 22 along the working surface of the workpiece to perform a trimming operation. Once the desired position of the second guide member 18 has been set by the user, further adjustment of the door trimmer 10 (e.g., manually clamping a door trimmer to a workpiece) to sufficiently maintain the position of the door trimmer 10 along the workpiece is not needed.

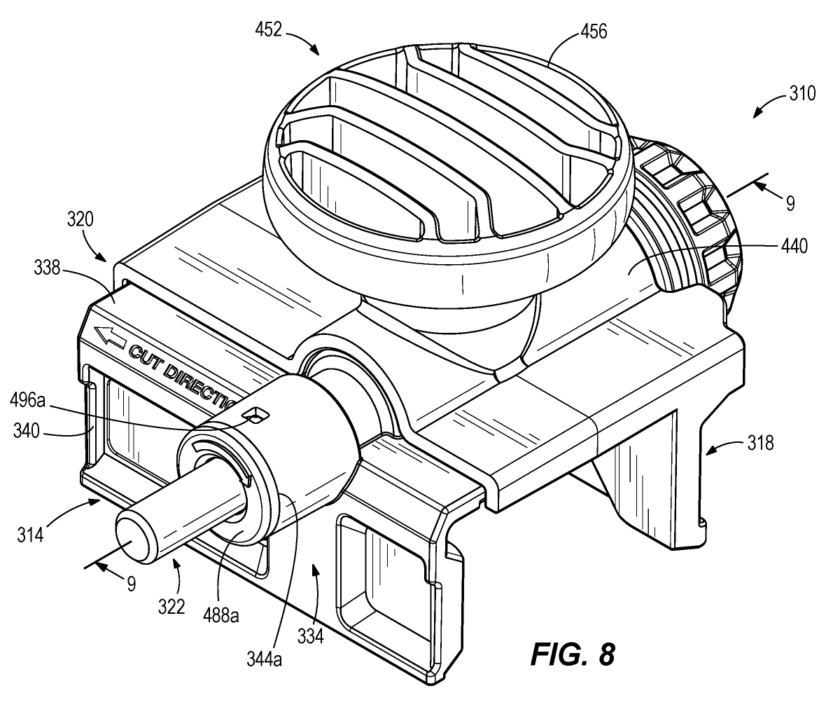

FIGS. 8-11 illustrate another door trimmer 310. The door trimmer 310 is similar to the door trimmer 10 of FIGS. 1-7; therefore, like structure will be identified by like reference number plus “300” and only the differences will be discussed hereafter.

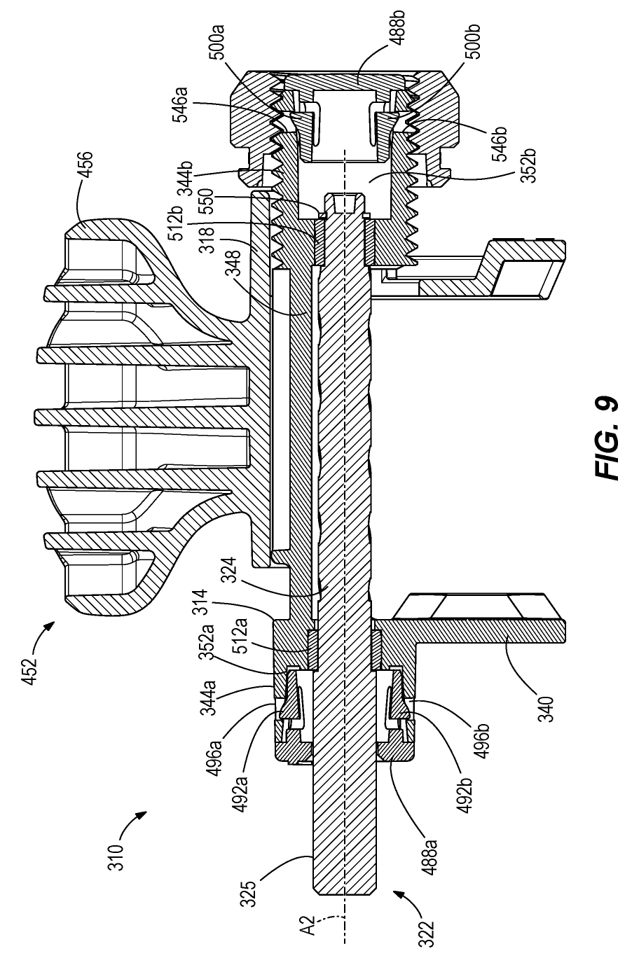

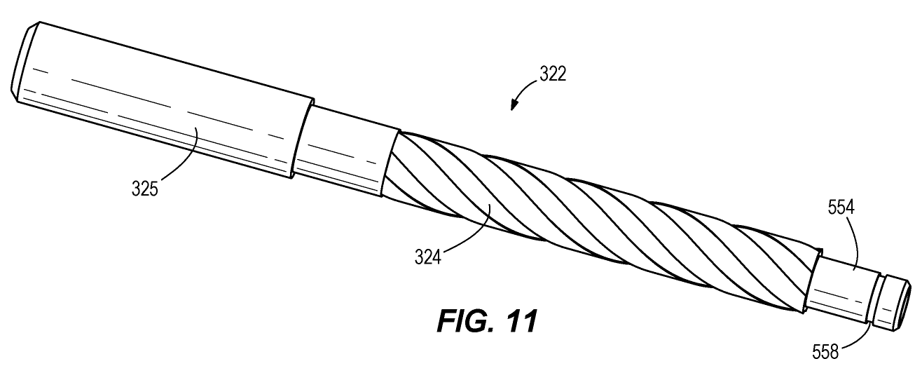

The door trimmer 310 includes a first guide member 314, a second guide member 318 coupled to the first guide member 314 to form a workpiece receiving assembly 320, and a tool bit 322 having a cutting portion 324 and a shank portion 325 (FIG. 11). The tool bit 322 is rotatably supported by the first guide member 314 such that the tool bit 322 is rotatable relative to the workpiece receiving assembly 320 about a longitudinal axis A2 (FIG. 9) defined by the tool bit 322. The first guide member 314 has a tool bit-receiving portion 334, a first planar portion 338, and a first guide wall 340 extending from the first planar portion 338. The tool bit-receiving portion 334 of the first guide member 314 has a first receiving portion 344a extending outwardly from the first guide wall 340, a second receiving portion 344b extending outwardly from the first planar portion 338, and an arcuate portion 348 extending therebetween. In addition, the door trimmer 310 further includes a handle 452 having a grip portion 456 that is integrally formed with an arcuate wall 440 of the second guide member 318.

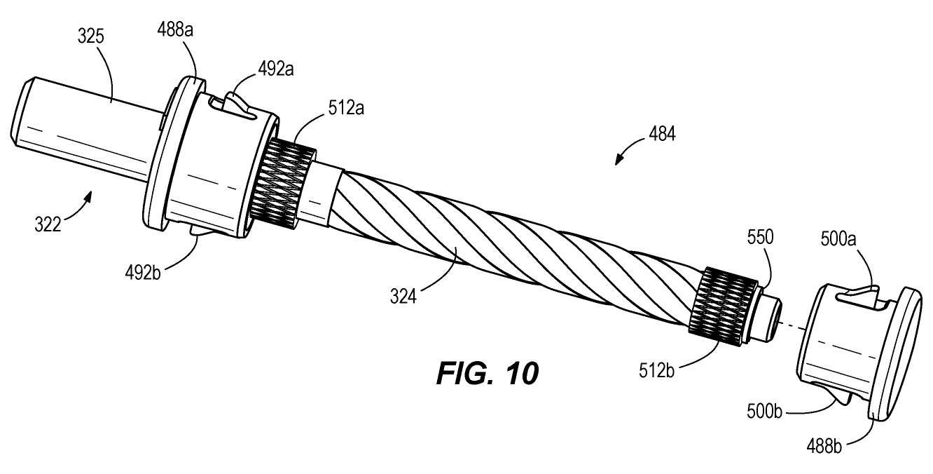

With reference to FIGS. 9 and 10, the door trimmer 310 further includes a retainer assembly 484 configured to inhibit axial movement of the tool bit 322 during the trimming operation. The retainer assembly 484 has a first retaining member or a first plug 488a and a second retaining member or a second plug 488b. The first plug 488a is received within a first aperture 352a of the first receiving portion 344a. The first plug 488a has two depressible tabs 492a, 492b configured to extend into a pair of holes 496a, 496b defined within the first receiving portion 344a, and thereby secure the first plug 488a within the first receiving portion 344a. The second plug 488b is received within a second aperture 352b of the second receiving portion 344b. The second plug 488b also has two depressible tabs 500a, 500b configured to extend into a pair of holes 546a, 546b defined within the second receiving portion 344b to secure the second plug 488b within the second receiving portion 344b.

In addition, the retainer assembly 484 has a first bushing 512a, a second bushing 512b, and a retaining ring or a snap ring 550. In the illustrated embodiment, each bushing 512a, 512b is a knurled bushing. In other embodiments, each bushing 512a, 512b may be a bushing with a smooth surface. The first bushing 512a is arranged along the shank portion 325 of the tool bit 322 and disposed within the first aperture 352a of the first receiving portion 344a. The second bushing 512b is arranged along a tool bit tip 554 of the tool bit 322 that extends from the cutting portion 324. As such, the second bushing 512b is disposed within the second aperture 352b of the second receiving portion 344b. The tool bit 322 extends through the first and second bushings 512a, 512b to be rotatably supported.

A groove 558 (FIG. 11) is defined within the tool bit tip 554 of the tool bit 322. The snap ring 550 is received within the groove 558 of the tool bit tip 554. When the tool bit 322 is securely coupled to the workpiece receiving assembly 320, the snap ring 550 abuts the second bushing 512b and thereby inhibits axial movement of the tool bit 322 in a direction towards the first plug 488a. For removal of the tool bit 322 from the first guide member 314 of the workpiece receiving assembly 320, the depressible tabs 492a, 492b of the first plug 488a may be depressed to remove the first plug 488a from the first receiving portion 344a and the depressible tabs 500a, 500b of the second plug 488b may be depressed to remove the second plug 488b from the second receiving portion 344b.

Although the invention has been described in detail with reference to certain preferred embodiments, variations and modifications exist within the scope and spirit of one or more independent aspects of the invention as described.

Various features of the present invention are set forth in the following claims.

What is claimed is:

1. A door trimmer for use with a power tool, the door trimmer comprising:
a workpiece receiving assembly including
a first guide member, and
a second guide member coupled to the first guide member to form a workpiece receiving space therebetween, the workpiece receiving space defining a distance between the first guide member and the second guide member;
a tool bit extending between the first guide member and the second guide member, the tool bit configured to be operably coupled to the power tool for rotation relative to the workpiece receiving assembly about a longitudinal axis; and
an actuator coupled to the workpiece receiving assembly, the actuator being rotatable about the longitudinal axis to change the distance between the first guide member and the second guide member.

2. The door trimmer of claim 1, wherein the first guide member and the second guide member are slidably coupled to each other to change the distance.

3. The door trimmer of claim 2, wherein the second guide member is slidable relative to the first guide member to change the distance.

4. The door trimmer of claim 1, wherein the first guide member has a first guide wall extending perpendicular to the longitudinal axis and the second guide member has a second guide wall extending perpendicular to the longitudinal axis, the first guide member and the second guide member are spaced from each other such that the distance is defined therebetween.

5. The door trimmer of claim 1, wherein the first guide member has an opening defined therein, and wherein the tool bit extends through the opening to be exposed.

6. The door trimmer of claim 1, wherein the actuator is threadably coupled to the first guide member.

7. The door trimmer of claim 1, further comprising a handle coupled to the workpiece receiving assembly.

8. A door trimmer for use with a power tool, the door trimmer comprising:
a tool bit configured to be operably coupled to the power tool for rotation upon actuation of the power tool;
a first guide member that rotatably supports the tool bit for rotation relative to the first guide member, the first guide member having a notch defined therein;
a second guide member having an arm extending therefrom and a tab that is received within the notch of the first guide member to slidably couple the second guide member to the first guide member; and
an actuator having a groove that receives the arm of the second guide member such that rotation of the actuator changes a distance defined between the first guide member and the second guide member.

9. The door trimmer of claim 8, wherein rotation of the actuator causes sliding movement of the second guide member relative to the first guide member to change the distance.

10. The door trimmer of claim 9, wherein the first guide member has a stop member and the second guide member has a recess defined therein, the recess of the second guide member is configured to receive the stop member of the first guide member to limit movement of the second guide member relative to the first guide member.

11. The door trimmer of claim 8, wherein the notch is a first notch and the tab is a first tab, wherein the first guide member has a second notch defined therein and the second guide member has a second tab that is received within the second notch.

12. The door trimmer of claim 8, wherein the arm is a first arm, wherein the second guide member has a second arm extending therefrom, and wherein the groove of the actuator also receives the second arm.

13. A door trimmer for use with a power tool, the door trimmer comprising:
a tool bit configured to be operably coupled to the power tool for rotation about a longitudinal axis;
a first guide member that rotatably supports the tool bit for rotation relative to the first guide member, the first guide member having a first guide wall extending perpendicular to the longitudinal axis;
a second guide member having a second guide wall oriented parallel to and spaced a distance from the first guide wall, the tool bit extending between the first guide wall and the second guide wall;
a retainer assembly coupled to the first guide member to inhibit axial movement of the tool bit relative to the first guide member; and
an actuator coupled to the second guide member, the actuator configured to rotate about the longitudinal axis to change the distance between the first guide wall and the second guide wall.

14. The door trimmer of claim 13, wherein the retainer assembly has a retaining member removable from the first guide member for removal of the tool bit from the first guide member.

15. The door trimmer of claim 14, wherein the retaining member has a tab that extends into the first guide member to secure the retaining member to the first guide member, and wherein the tab is depressible to allow removal of the retaining member from the first guide member.

16. The door trimmer of claim 14, wherein the retainer assembly includes a bushing for rotatably supporting the tool bit.

17. The door trimmer of claim 13, wherein rotation of the actuator causes sliding movement of the second guide member relative to the first guide member to change the distance.

18. The door trimmer of claim 17, wherein the second guide member has an arm that is received by the actuator to couple the actuator to the second guide member.

19. The door trimmer of claim 13, wherein the actuator is threadably coupled to the first guide member.

20. The door trimmer of claim 13, wherein the actuator is a knob.
